(19) United States
(12) Patent Application Publication
(10) Pub. No.: US 2023/0224764 A1
(43) Pub. Date: Jul. 13, 2023

(54) SIDELINK RECEIVER-SIDE PROTECTION FOR A MULTIPLE TRANSMITTER-RECEIVER POINT USER EQUIPMENT

(71) Applicant: QUALCOMM Incorporated, San Diego, CA (US)

(72) Inventors: Sourjya DUTTA, San Diego, CA (US); Kapil GULATI, Belle Mead, NJ (US); Hui GUO, Beijing (CN); Junyi LI, Fairless Hills, PA (US); Shuanshuan WU, San Diego, CA (US)

(21) Appl. No.: 18/000,979

(22) PCT Filed: Jul. 29, 2020
(86) PCT No.: PCT/CN2020/105389

§ 371 Date: Dec. 7, 2022

(51) Int. Cl. H04W 28/26; H04W 72/25; H04W 72/543

(52) U.S. Cl. CPC H04W 28/26; H04W 72/25; H04W 72/543

(57) ABSTRACT

Various aspects of the present disclosure generally relate to wireless communication. In some aspects, a first user equipment (UE) may determine a communication collision between a first reservation, by a second UE, of a sidelink resource and a second reservation of the sidelink resource based at least in part on a first set of estimated reference signal received quality (RSRQ) values associated with the first reservation and a second set of estimated RSRQ values associated with the second reservation, wherein the first set of estimated RSRQ values corresponds to a plurality of transmitter-receiver points (TRPs) of the first UE, and wherein the second set of estimated RSRQ values corresponds to the plurality of TRPs. The UE may perform an action based at least in part on identifying the communication collision. Numerous other aspects are provided.

### FIELD OF THE DISCLOSURE

Aspects of the present disclosure generally relate to wireless communication and to techniques and apparatuses for sidelink receiver-side protection for a multiple transmitter-receiver point user equipment.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, and/or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include a number of base stations (BSs) that can support communication for a number of user equipment (UEs). A user equipment (UE) may communicate with a base station (BS) via the downlink and uplink. The downlink (or forward link) refers to the communication link from the BS to the UE, and the uplink (or reverse link) refers to the communication link from the UE to the BS. As will be described in more detail herein, a BS may be referred to as a Node B, a gNB, an access point (AP), a radio head, a transmit receive point (TRP), a New Radio (NR) BS, a 5G Node B, and/or the like.

The above multiple access technologies have been adopted in various telecommunication standards to provide a common protocol that enables different user equipment to communicate on a municipal, national, regional, and even global level. New Radio (NR), which may also be referred to as 5G, is a set of enhancements to the LTE mobile standard promulgated by the Third Generation Partnership Project (3GPP). NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some aspects, a method of wireless communication performed by a first user equipment (UE) includes determining a communication collision between a first reservation, by a second UE, of a sidelink resource and a second reservation, by a third UE, of the sidelink resource based at least in part on a first set of estimated reference signal received quality (RSRQ) values associated with the first reservation and a second set of estimated RSRQ values associated with the second reservation, wherein the first set of estimated RSRQ values corresponds to a plurality of transmitter-receiver points (TRPs) of the first UE, and wherein the second set of estimated RSRQ values corresponds to the plurality of TRPs; and performing an action based at least in part on identifying the communication collision.

In some aspects, a first UE for wireless communication includes a memory; and one or more processors operatively coupled to the memory, the memory and the one or more processors configured to determine a communication collision between a first reservation, by a second UE, of a sidelink resource and a second reservation of the sidelink resource based at least in part on a first set of estimated RSRQ values associated with the first reservation and a second set of estimated RSRQ values associated with the second reservation, wherein the first set of estimated RSRQ values corresponds to a plurality of TRPs of the first UE, and wherein the second set of estimated RSRQ values corresponds to the plurality of TRPs; and perform an action based at least in part on identifying the communication collision.

In some aspects, a non-transitory computer-readable medium storing a set of instructions for wireless communication includes one or more instructions that, when executed by one or more processors of a first UE, cause the UE to determine a communication collision between a first reservation, by a second UE, of a sidelink resource and a second reservation of the sidelink resource based at least in part on a first set of estimated RSRQ values associated with the first reservation and a second set of estimated RSRQ values associated with the second reservation, wherein the first set of estimated RSRQ values corresponds to a plurality of TRPs of the first UE, and wherein the second set of estimated RSRQ values corresponds to the plurality of TRPs; and perform an action based at least in part on identifying the communication collision.

In some aspects, an apparatus for wireless communication includes means for determining a communication collision between a first reservation, by a second apparatus, of a sidelink resource and a second reservation of the sidelink resource based at least in part on a first set of estimated RSRQ values associated with the first reservation and a second set of estimated RSRQ values associated with the second reservation, wherein the first set of estimated RSRQ values corresponds to a plurality of TRPs of the first apparatus, and wherein the second set of estimated RSRQ values corresponds to the plurality of TRPs; and means for performing an action based at least in part on identifying the communication collision.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with various aspects of the present disclosure.

FIG. 2 is a diagram illustrating an example of a base station in communication with a UE in a wireless network, in accordance with various aspects of the present disclosure.

FIG. 3 is a diagram illustrating an example of sidelink communications, in accordance with various aspects of the present disclosure.

FIG. 4 is a diagram illustrating an example of sidelink communications and access link communications, in accordance with various aspects of the present disclosure.

FIG. 5 is a diagram illustrating an example of sidelink communications including a multiple transmitter-receiver point (mTRP) UE, in accordance with various aspects of the present disclosure.

FIG. 6 is a diagram illustrating an example associated with sidelink receiver-side protection for an mTRP UE, in accordance with various aspects of the present disclosure.

FIG. 7 is a diagram illustrating an example process associated with sidelink receiver-side protection for an mTRP UE, in accordance with various aspects of the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein, one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, and/or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described herein using terminology commonly associated with a 5G or NR radio access technology (RAT), aspects of the present disclosure can be applied to other RATs, such as a 3G RAT, a 4G RAT, and/or a RAT subsequent to 5G (e.g., 6G).

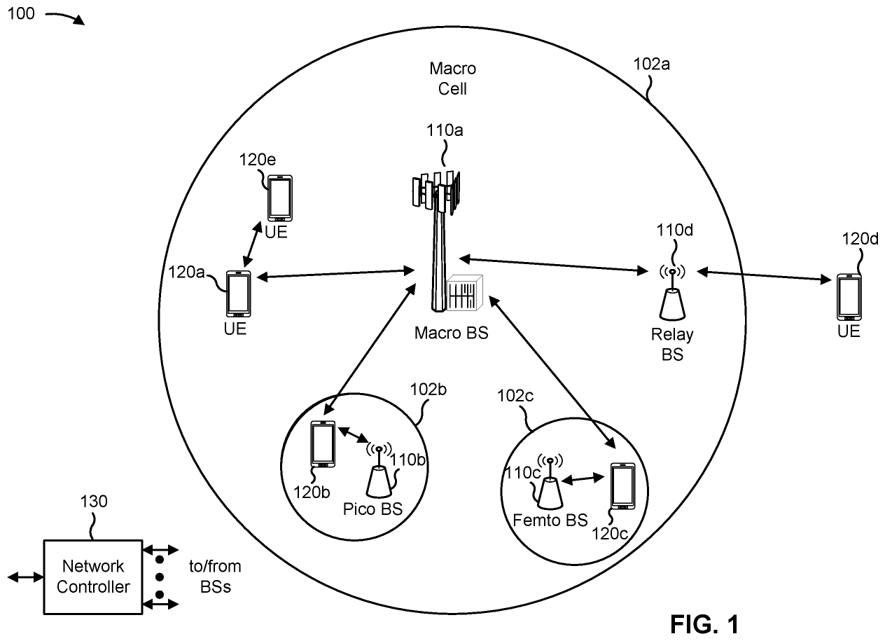

FIG. 1 is a diagram illustrating an example of a wireless network 100, in accordance with various aspects of the present disclosure. The wireless network 100 may be or may include elements of a 5G (NR) network, an LTE network, and/or the like. The wireless network 100 may include a number of base stations 110 (shown as BS 110a, BS 110b, BS 110c, and BS 110d) and other network entities. A base station (BS) is an entity that communicates with user equipment (UEs) and may also be referred to as an NR BS, a Node B, a gNB, a 5G node B (NB), an access point, a transmit receive point (TRP), and/or the like. Each BS may provide communication coverage for a particular geographic area. In 3GPP, the term “cell” can refer to a coverage area of a BS and/or a BS subsystem serving this coverage area, depending on the context in which the term is used.

A BS may provide communication coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). A BS for a macro cell may be referred to as a macro BS. A BS for a pico cell may be referred to as a pico BS. ABS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. ABS may support one or multiple (e.g., three) cells. The terms “eNB”, “base station”, “NR BS”, “gNB”, “TRP”, “AP”, “node B”, “5G NB”, and “cell” may be used interchangeably herein.

In some aspects, a cell may not necessarily be stationary, and the geographic area of the cell may move according to the location of a mobile BS. In some aspects, the BSs may be interconnected to one another and/or to one or more other BSs or network nodes (not shown) in the wireless network 100 through various types of backhaul interfaces such as a direct physical connection, a virtual network, and/or the like using any suitable transport network.

Wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay BS 110d may communicate with macro BS 110a and a UE 120d in order to facilitate communication between BS 110a and UE 120d. A relay BS may also be referred to as a relay station, a relay base station, a relay, and/or the like.

Wireless network 100 may be a heterogeneous network that includes BSs of different types, e.g., macro BSs, pico BSs, femto BSs, relay BSs, and/or the like. These different types of BSs may have different transmit power levels, different coverage areas, and different impacts on interference in wireless network 100. For example, macro BSs may have a high transmit power level (e.g., 5 to 40 watts) whereas pico BSs, femto BSs, and relay BSs may have lower transmit power levels (e.g., 0.1 to 2 watts).

A network controller 130 may couple to a set of BSs and may provide coordination and control for these BSs. Network controller 130 may communicate with the BSs via a backhaul. The BSs may also communicate with one another, e.g., directly or indirectly via a wireless or wireline backhaul.

UEs 120 (e.g., 120a, 120b, 120c) may be dispersed throughout wireless network 100, and each UE may be stationary or mobile. A UE may also be referred to as an access terminal, a terminal, a mobile station, a subscriber unit, a station, and/or the like. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

Some UEs may be considered machine-type communication (MTC) or evolved or enhanced machine-type communication (eMTC) UEs. MTC and eMTC UEs include, for example, robots, drones, remote devices, sensors, meters, monitors, location tags, and/or the like, that may communicate with a base station, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, and/or may be implemented as NB-IoT (narrowband internet of things) devices. Some UEs may be considered a Customer Premises Equipment (CPE). UE 120 may be included inside a housing that houses components of UE 120, such as processor components, memory components, and/or the like. In some aspects, the processor components and the memory components may be coupled together. For example, the processor components (e.g., one or more processors) and the memory components (e.g., a memory) may be operatively coupled, communicatively coupled, electronically coupled, electrically coupled, and/or the like.

In general, any number of wireless networks may be deployed in a given geographic area. Each wireless network may support a particular RAT and may operate on one or more frequencies. A RAT may also be referred to as a radio technology, an air interface, and/or the like. A frequency may also be referred to as a carrier, a frequency channel, and/or the like. Each frequency may support a single RAT in a given geographic area in order to avoid interference between wireless networks of different RATs. In some cases, NR or 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, vehicle-to-pedestrian (V2P), and/or the like), a mesh network, and/or the like. In this case, the UE 120 may perform scheduling operations, resource selection operations, and/or other operations described elsewhere herein as being performed by the base station 110.

Devices of wireless network 100 may communicate using the electromagnetic spectrum, which may be subdivided based on frequency or wavelength into various classes, bands, channels, and/or the like. For example, devices of wireless network 100 may communicate using an operating band having a first frequency range (FR1), which may span from 410 MHz to 7.125 GHz, and/or may communicate using an operating band having a second frequency range (FR2), which may span from 24.25 GHz to 52.6 GHz. The frequencies between FR1 and FR2 are sometimes referred to as mid-band frequencies. Although a portion of FR1 is greater than 6 GHz, FR1 is often referred to as a “sub-6 GHz” band. Similarly, FR2 is often referred to as a “millimeter wave” band despite being different from the extremely high frequency (EHF) band (30 GHz-300 GHz) which is identified by the International Telecommunications Union (ITU) as a “millimeter wave” band. Thus, unless specifically stated otherwise, it should be understood that the term “sub-6 GHz” or the like, if used herein, may broadly represent frequencies less than 6 GHz, frequencies within FR1, and/or mid-band frequencies (e.g., greater than 7.125 GHz). Similarly, unless specifically stated otherwise, it should be understood that the term “millimeter wave” or the like, if used herein, may broadly represent frequencies within the EHF band, frequencies within FR2, and/or mid-band frequencies (e.g., less than 24.25 GHz). It is contemplated that the frequencies included in FR1 and FR2 may be modified, and techniques described herein are applicable to those modified frequency ranges.

As indicated above, FIG. 1 is provided as an example. Other examples may differ from what is described with regard to FIG. 1.

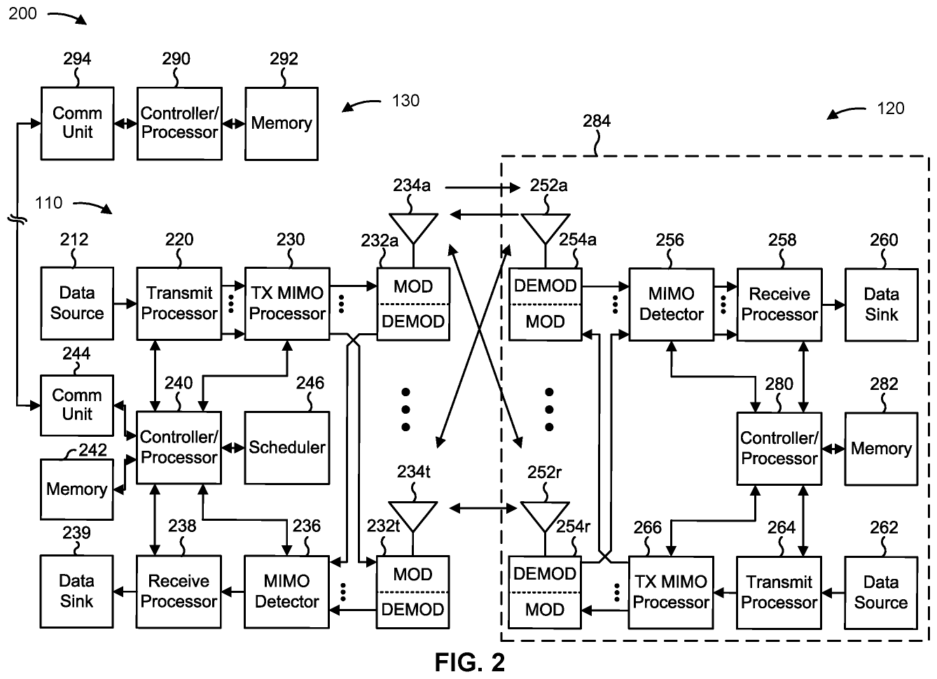

FIG. 2 is a diagram illustrating an example 200 of a base station 110 in communication with a UE 120 in a wireless network 100, in accordance with various aspects of the present disclosure. Base station 110 may be equipped with T antennas 234a through 234t, and UE 120 may be equipped with R antennas 252a through 252r, where in general T≥1 and R≥1.

At base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI) and/or the like) and control information (e.g., CQI requests, grants, upper layer signaling, and/or the like) and provide overhead symbols and control symbols. Transmit processor 220 may also generate reference symbols for reference signals (e.g., a cell-specific reference signal (CRS), a demodulation reference signal (DMRS), and/or the like) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for OFDM and/or the like) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively.

At UE 120, antennas 252a through 252r may receive the downlink signals from base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 120 to a data sink 260, and provide decoded control information and system information to a controller/processor 280. The term “controller/processor” may refer to one or more controllers, one or more processors, or a combination thereof. A channel processor may determine reference signal received power (RSRP), received signal strength indicator (RSSI), reference signal received quality (RSRQ), channel quality indicator (CQI), and/or the like. In some aspects, one or more components of UE 120 may be included in a housing 284.

Network controller 130 may include communication unit 294, controller/processor 290, and memory 292. Network controller 130 may include, for example, one or more devices in a core network. Network controller 130 may communicate with base station 110 via communication unit 294.

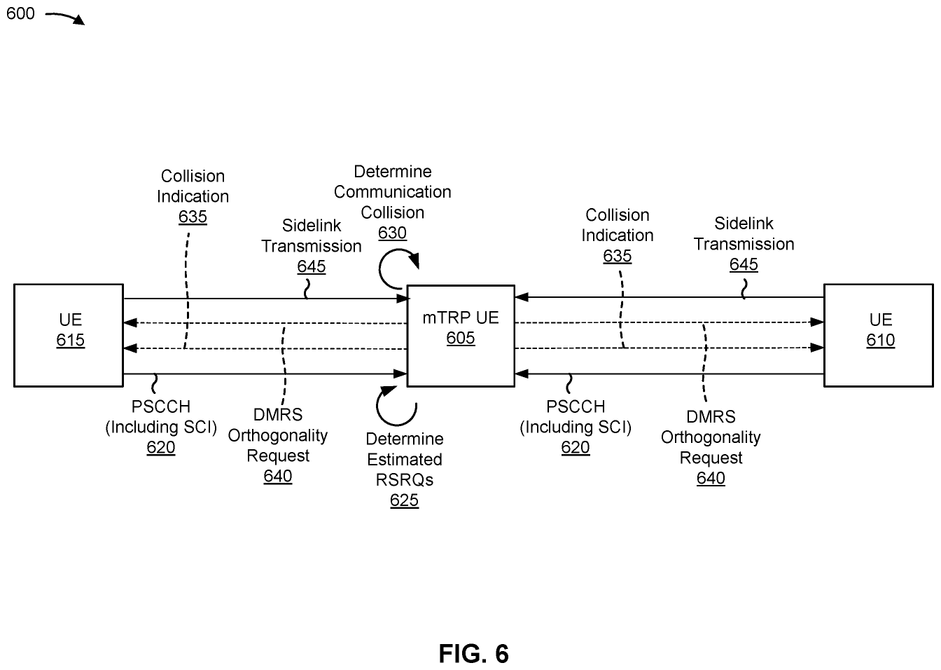

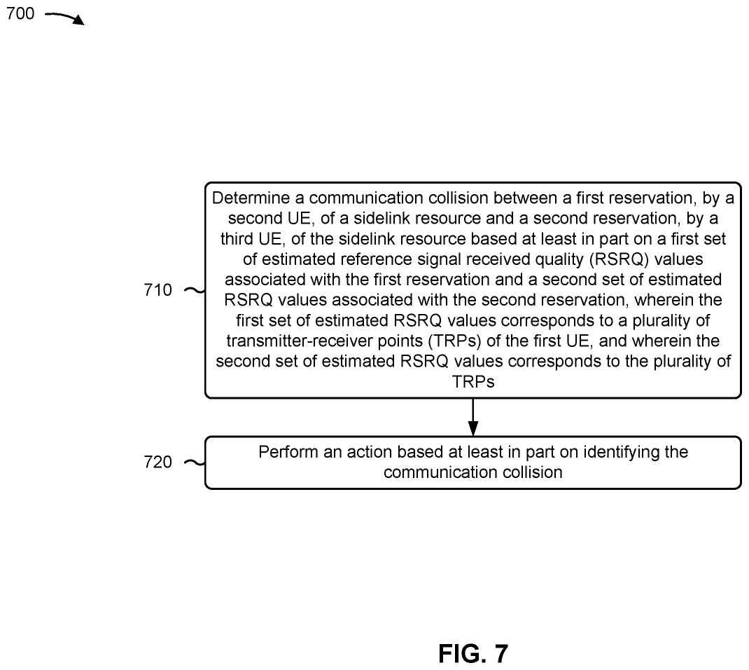

On the uplink, at UE 120, a transmit processor 264 may receive and process data from a data source 262 and control information (e.g., for reports that include RSRP, RSSI, RSRQ, CQI, and/or the like) from controller/processor 280. Transmit processor 264 may also generate reference symbols for one or more reference signals. The symbols from transmit processor 264 may be precoded by a TX MIMO processor 266 if applicable, further processed by modulators 254a through 254r (e.g., for DFT-s-OFDM, CP-OFDM, and/or the like), and transmitted to base station 110. In some aspects, the UE 120 includes a transceiver. The transceiver may include any combination of antenna(s) 252, modulators and/or demodulators 254, MIMO detector 256, receive processor 258, transmit processor 264, and/or TX MIMO processor 266. The transceiver may be used by a processor (e.g., controller/processor 280) and memory 282 to perform aspects of any of the methods described herein, for example, as described with reference to FIGS. 6-7.

At base station 110, the uplink signals from UE 120 and other UEs may be received by antennas 234, processed by demodulators 232, detected by a MIMO detector 236 if applicable, and further processed by a receive processor 238 to obtain decoded data and control information sent by UE 120. Receive processor 238 may provide the decoded data to a data sink 239 and the decoded control information to controller/processor 240. Base station 110 may include communication unit 244 and communicate to network controller 130 via communication unit 244. Base station 110 may include a scheduler 246 to schedule UEs 120 for downlink and/or uplink communications. In some aspects, the base station 110 includes a transceiver. The transceiver may include any combination of antenna(s) 234, modulators and/or demodulators 232, MIMO detector 236, receive processor 238, transmit processor 220, and/or TX MIMO processor 230. The transceiver may be used by a processor (e.g., controller/processor 240) and memory 242 to perform aspects of any of the methods described herein, for example, as described with reference to FIGS. 6-7.

Controller/processor 240 of base station 110, controller/processor 280 of UE 120, and/or any other component(s) of FIG. 2 may perform one or more techniques associated with sidelink receiver-side protection for a multiple transmitter-receiver point (mTRP) UE, as described in more detail elsewhere herein. For example, controller/processor 240 of base station 110, controller/processor 280 of UE 120, and/or any other component(s) of FIG. 2 may perform or direct operations of, for example, process 700 of FIG. 7 and/or other processes as described herein. Memories 242 and 282 may store data and program codes for base station 110 and UE 120, respectively. In some aspects, memory 242 and/or memory 282 may include a non-transitory computer-readable medium storing one or more instructions (e.g., code, program code, and/or the like) for wireless communication. For example, the one or more instructions, when executed (e.g., directly, or after compiling, converting, interpreting, and/or the like) by one or more processors of the base station 110 and/or the UE 120, may cause the one or more processors, the UE 120, and/or the base station 110 to perform or direct operations of, for example, process 700 of FIG. 7 and/or other processes as described herein. In some aspects, executing instructions may include running the instructions, converting the instructions, compiling the instructions, interpreting the instructions, and/or the like.

In some aspects, UE 120 may include means for determining, using a resource exclusion procedure that is biased based at least in part on an indication of a directional bias, a set of available resources for a sidelink transmission, means for transmitting the sidelink transmission using the set of available resources and at least one transmitter-receiver point (TRP) of a plurality of TRPs of the UE, and/or the like. In some aspects, such means may include one or more components of UE 120 described in connection with FIG. 2, such as controller/processor 280, transmit processor 264, TX MIMO processor 266, MOD 254, antenna 252, DEMOD 254, MIMO detector 256, receive processor 258, and/or the like.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of controller/processor 280.

As indicated above, FIG. 2 is provided as an example. Other examples may differ from what is described with regard to FIG. 2.

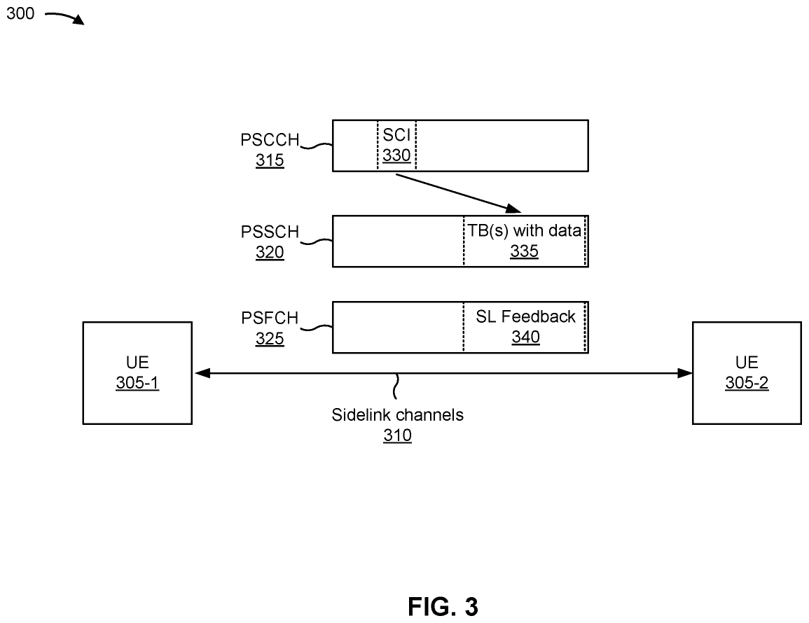

FIG. 3 is a diagram illustrating an example 300 of sidelink communications, in accordance with various aspects of the present disclosure.

As shown in FIG. 3, a first UE 305-1 may communicate with a second UE 305-2 (and one or more other UEs 305) via one or more sidelink channels 310. The UEs 305-1 and 305-2 may communicate using the one or more sidelink channels 310 for P2P communications, D2D communications, V2X communications (e.g., which may include V2V communications, V2I communications, V2P communications, and/or the like), mesh networking, and/or the like. In some aspects, the UEs 305 (e.g., UE 305-1 and/or UE 305-2) may correspond to one or more other UEs described elsewhere herein, such as UE 120. In some aspects, the one or more sidelink channels 310 may use a PC5 interface and/or may operate in a high frequency band (e.g., the 5.9 GHz band). Additionally, or alternatively, the UEs 305 may synchronize timing of transmission time intervals (TTIs) (e.g., frames, subframes, slots, symbols, and/or the like) using global navigation satellite system (GNSS) timing.

As further shown in FIG. 3, the one or more sidelink channels 310 may include a physical sidelink control channel (PSCCH) 315, a physical sidelink shared channel (PSSCH) 320, and/or a physical sidelink feedback channel (PSFCH) 325. The PSCCH 315 may be used to communicate control information, similar to a physical downlink control channel (PDCCH) and/or a physical uplink control channel (PUCCH) used for cellular communications with a base station 110 via an access link or an access channel. The PSSCH 320 may be used to communicate data, similar to a physical downlink shared channel (PDSCH) and/or a physical uplink shared channel (PUSCH) used for cellular communications with a base station 110 via an access link or an access channel. For example, the PSCCH 315 may carry sidelink control information (SCI) 330, which may indicate various control information used for sidelink communications, such as one or more resources (e.g., time resources, frequency resources, spatial resources, and/or the like) where a transport block (TB) 335 may be carried on the PSSCH 320. The TB 335 may include data. The PSFCH 325 may be used to communicate sidelink feedback 340, such as hybrid automatic repeat request (HARQ) feedback (e.g., acknowledgement or negative acknowledgement (ACK/NACK) information), transmit power control (TPC), a scheduling request (SR), and/or the like.

In some aspects, the one or more sidelink channels 310 may use resource pools. For example, a scheduling assignment (e.g., included in SCI 330) may be transmitted in sub-channels using specific resource blocks (RBs) across time. In some aspects, data transmissions (e.g., on the PSSCH 320) associated with a scheduling assignment may occupy adjacent RBs in the same subframe as the scheduling assignment (e.g., using frequency division multiplexing). In some aspects, a scheduling assignment and associated data transmissions are not transmitted on adjacent RBs.

In some aspects, a UE 305 may operate using a transmission mode where resource selection and/or scheduling is performed by the UE 305 (e.g., rather than a base station 110). In some aspects, the UE 305 may perform resource selection and/or scheduling by sensing channel availability for transmissions. For example, the UE 305 may measure a received signal strength indicator (RSSI) parameter (e.g., a sidelink-RSSI (S-RSSI) parameter) associated with various sidelink channels, may measure a reference signal received power (RSRP) parameter (e.g., a PSSCH-RSRP parameter) associated with various sidelink channels, may measure a reference signal received quality (RSRQ) parameter (e.g., a PSSCH-RSRQ parameter) associated with various sidelink channels, and/or the like, and may select a channel for transmission of a sidelink communication based at least in part on the measurement(s).

Additionally, or alternatively, the UE 305 may perform resource selection and/or scheduling using SCI 330 received in the PSCCH 315, which may indicate occupied resources, channel parameters, and/or the like. Additionally, or alternatively, the UE 305 may perform resource selection and/or scheduling by determining a channel busy rate (CBR) associated with various sidelink channels, which may be used for rate control (e.g., by indicating a maximum number of resource blocks that the UE 305 can use for a particular set of subframes).

In the transmission mode where resource selection and/or scheduling is performed by a UE 305, the UE 305 may generate sidelink grants, and may transmit the grants in SCI 330. A sidelink grant may indicate, for example, one or more parameters (e.g., transmission parameters) to be used for an upcoming sidelink transmission, such as one or more resource blocks to be used for the upcoming sidelink transmission on the PSSCH 320 (e.g., for TBs 335), one or more subframes to be used for the upcoming sidelink transmission, a modulation and coding scheme (MCS) to be used for the upcoming sidelink transmission, and/or the like. In some aspects, a UE 305 may generate a sidelink grant that indicates one or more parameters for semi-persistent scheduling (SPS), such as a periodicity of a sidelink transmission. Additionally, or alternatively, the UE 305 may generate a sidelink grant for event-driven scheduling, such as for an on-demand sidelink message.

As indicated above, FIG. 3 is provided as an example. Other examples may differ from what is described with respect to FIG. 3.

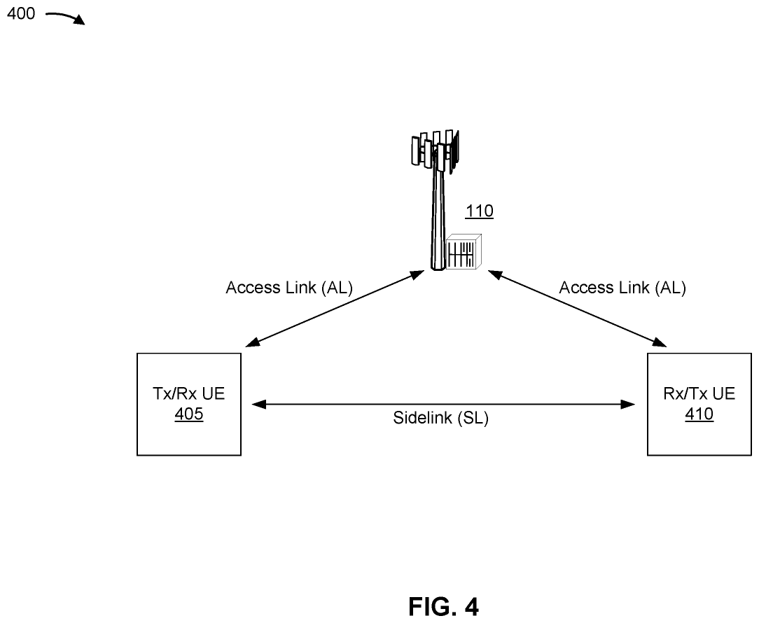

FIG. 4 is a diagram illustrating an example 400 of sidelink communications and access link communications, in accordance with various aspects of the present disclosure.

As shown in FIG. 4, a transmitter (Tx)/receiver (Rx) UE 405 and an Rx/Tx UE 410 may communicate with one another via a sidelink, as described above in connection with FIG. 3. As further shown, in some sidelink modes, a base station 110 may communicate with the Tx/Rx UE 405 via a first access link. Additionally, or alternatively, in some sidelink modes, the base station 110 may communicate with the Rx/Tx UE 410 via a second access link. The Tx/Rx UE 405 and/or the Rx/Tx UE 410 may correspond to one or more UEs described elsewhere herein, such as the UE 120 of FIG. 1. Thus, a direct link between UEs 120 (e.g., via a PC5 interface) may be referred to as a sidelink, and a direct link between a base station 110 and a UE 120 (e.g., via a Uu interface) may be referred to as an access link. Sidelink communications may be transmitted via the sidelink, and access link communications may be transmitted via the access link. An access link communication may be either a downlink communication (from a base station 110 to a UE 120) or an uplink communication (from a UE 120 to a base station 110).

As indicated above, FIG. 4 is provided as an example. Other examples may differ from what is described with respect to FIG. 4.

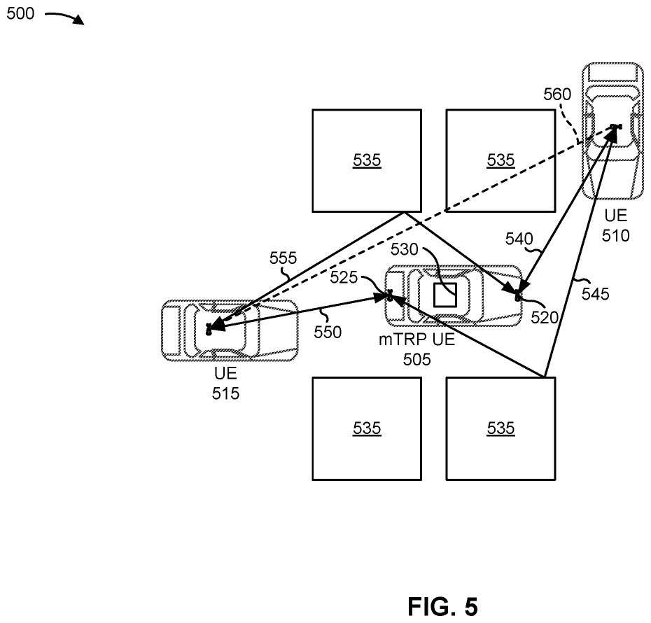

FIG. 5 is a diagram illustrating an example 500 of sidelink communications including an mTRP UE 505, in accordance with various aspects of the present disclosure. As shown, the mTRP UE 505 may communicate with a UE 510 and a UE 515. The UEs 505, 510, and 515 may communicate using sidelink communications.

The UEs 505, 510, and/or 515 may be, be similar to, include, or be included in a UE or UEs as described herein (e.g., UE 120 shown in FIG. 1). In some aspects, the mTRP UE 505 may be, include, or be included in a vehicle (as shown), a trailer, and/or the like. As shown, the UE 510 and/or the UE 515 may be, include, or be included in a vehicle (as shown), a trailer, and/or the like. In some aspects, the UE 510 and/or the UE 515 may be an mTRP UE. In some aspects, the mTRP UE 505 may communicate with additional UEs not depicted in FIG. 5.

As shown in FIG. 5, the mTRP UE 505 may include a first TRP 520, a second TRP 525, and a controller 530. In some aspects, for example, a car may have front and rear antenna panels. These antenna panels may be TRPs. In some aspects, the mTRP UE 505 may include additional TRPs (not shown in FIG. 5). In some aspects, the controller 530 may include hardware and/or software that controls the first TRP 520 and the second TRP 525. For example, in some aspects, the controller 530 may include one or more processing components, one or more control components, one or more storage components, and/or the like, such as one or more components shown in FIG. 2 (e.g., the DEMOD/MOD 254a . . . 254r, the MIMO detector 256, the receive processor 258, the data sink 260, the data source 262, the transmit processor 264, the TX MIMO processor 266, the controller/processor 280, the memory 282, and/or the like). In some aspects, the TRP 520 and the TRP 525 may include respective RF components such as analog RF transmitter and/or receiver components, digital processing components, and/or the like, such as one or more components shown in FIG. 2 (e.g., the antennas 252a . . . 252r, the DEMOD/MOD 254a . . . 254r, the MIMO detector 256, the receive processor 258, the data sink 260, the data source 262, the transmit processor 264, the TX MIMO processor 266, the controller/processor 280, the memory 282, and/or the like).

In some aspects, TRPs on a vehicle may be spatially separated from one another. For example, in some aspects, a front TRP on a car may be separated from a rear TRP on the car by approximately 3 meters, 4 meters, and/or the like. A front TRP on a 16-wheel trailer may be separated from a rear TRP on the trailer by approximately 20 meters. As a result of any amount of separation, a sidelink communication channel may appear differently to one TRP than to another TRP of the same UE. That is, for example, a first TRP may experience a different signal quality than a second TRP, a different signal power than the second TRP, a different noise level than the second TRP, and/or the like. These differences may be caused by a difference in distance from a device (e.g., UE) with which the TRPs are communicating, lack of line of sight (LoS) with respect to one of the TRPs, signals blocking (e.g., by obstructions in the environment such as other UEs, vehicles, buildings, hills, and/or the like), and/or the like.

As shown in FIG. 5, some environments may include objects 535 that block signals, cause a lack of LoS between UEs, and/or the like. The objects 535 may include any number of different types of obstructing objects such as, for example, buildings, boulders, houses, walls, and/or the like. As shown in FIG. 5, for example, a communication link 540 between the UE 510 and the first TRP 520 may provide a higher quality signal than a communication link 545 between the UE 510 and the second TRP 525. The communication link 545 may be of lower quality due to a greater distance between the UE 510 and the second TRP 525 than between the UE 510 and the first TRP 520, a reflection of the communication link 545 off of an object 535, and/or the like. Similarly, as shown in FIG. 5, for example, a communication link 550 between the UE 510 and the second TRP 525 may provide a higher quality signal than a communication link 555 between the UE 510 and the first TRP 520.

In some aspects, obstructions may give rise to a hidden node problem, which is a common issue that affects sidelink communications in urban scenarios, for example. As shown in FIG. 5, the UE 510 and the UE 515 may be relatively close to one another, but a potential sidelink communication link 560 between them may be blocked or attenuated due to the objects 535. Thus, the UE 510 and 515 may not be able to decode control channel transmissions sent from one another. In this case, the UE 510 and the UE 515 may be unaware of one another, unaware of resources reserved by one another, and/or the like. As a result, the UE 510 and the UE 515 may reserve the same, or overlapping, sidelink resources for communicating with the mTRP UE 505, which may lead to a communication collision at the mTRP UE 505. The collision may occur even if mTRP UE 505 has high quality sidelink communication links with the UE 510 and the UE 515.

Some aspects of techniques and apparatuses described herein may facilitate sidelink receiver-side protection for an mTRP UE. In some aspects, an mTRP UE may determine a communication collision between a first reservation, by a second UE, of a sidelink resource and a second reservation, by a third UE, of the sidelink resource. The mTRP UE may determine the communication collision based at least in part on a first set of estimated reference signal received quality (RSRQ) measurements associated with the first reservation and a second set of estimated RSRQ values associated with the second reservation. The sets of estimated RSRQ values may correspond to a plurality of TRPs of the first UE. The mTRP UE may perform an action based at least in part on identifying the communication collision. In some aspects, the mTRP UE may transmit a collision notification to one of the UEs. In some aspects, the mTRP UE may determine that the colliding communications include the same (or similar) demodulation reference signals (DMRSs) and may transmit a request to one of the UEs to use a DMRS orthogonal to the original DMRS. In some aspects, the mTRP UE may decode a signal from a UE obtained by a first TRP and another signal from another UE obtained by a second TRP. In this way, the mTRP UE may use estimated RSRQ measurements to determine communication collisions and perform an action, thereby facilitating avoidance of unnecessary communication collisions.

As indicated above, FIG. 5 is provided as an example. Other examples may differ from what is described with respect to FIG. 5.

FIG. 6 is a diagram illustrating an example 600 associated with sidelink receiver-side protection for an mTRP UE, in accordance with various aspects of the present disclosure. As shown, an mTRP UE 605 may communicate with a UE 610 and a UE 615. In some aspects, the MTRP UE 605 may be, be similar to, include, or be included in the UE 120 shown in FIGS. 1 and 2, the mTRP UE 505 shown in FIG. 5, and/or the like. In some aspects, the UE 610 may be, be similar to, include, or be included in the UE 120 shown in FIGS. 1 and 2, the UE 510 shown in FIG. 5, the UE 515 shown in FIG. 5, and/or the like.

As shown by reference number 620, the UE 610 may transmit, and the mTRP UE 605 may receive, a physical sidelink control channel (PSCCH) transmission. As is also shown by reference number 620, the UE 615 may transmit, and the mTRP UE 605 may receive, a PSCCH transmission. The PSCCH transmissions may include sidelink control information (SCI). The mTRP UE 605 may decode the PSCCH transmissions to extract the SCI. In some aspects, the mTRP UE 605 (which may be referred to as a “first UE”) may use the SCI to identify a first reservation, by the UE 610 (which may be referred to as a “second UE”), of a sidelink resource; identify a second reservation, by the UE 615 (which may be referred to as a “third UE”), of the sidelink resource; facilitate determining communication collisions (e.g., between a potential sidelink communication associated with the first reservation and a potential sidelink communication associated with the second reservation); and/or the like.

As shown by reference number 625, the mTRP UE 605 may determine a first set of estimated RSRQ values associated with the first reservation and a second set of estimated RSRQ values associated with the second reservation. In some aspects, the first and second sets of estimated RSRQ values may correspond to a plurality of TRPs of the mTRP UE 605. For example, a first estimated RSRQ value of the first set of estimated RSRQ values may correspond to a first TRP of the mTRP UE 605 and a second estimated RSRQ value of the set of RSRQ values may correspond to a second TRP of the MTRP UE 605.

In some aspects, the mTRP UE 605 may determine the first set of estimated RSRQ values by obtaining, using a first TRP of the plurality of TRPs, a first reference signal received power (RSRP) measurement corresponding to the first SCI transmission. Similarly, the mTRP UE 605 may obtain, using the first TRP, a second RSRP measurement corresponding to the first SCI transmission.

In some aspects, the mTRP UE 605 may determine a first estimated RSRQ value of the first set of RSRQ values based at least in part on the first RSRP measurement and the second RSRP measurement. In some aspects, the mTRP UE 605 may determine the first estimated RSRQ value by determining a quotient of the first RSRP measurement divided by a divisor that includes the second RSRP measurement. In some aspects, the divisor comprises a sum of the second RSRP measurement and an estimated noise variance value. In some aspects, for example, the mTRP UE 605 may determine an estimated RSRQ value, RSRQ(1,1), where the first index indicates the TRP (the first TRP in this case) and the second index indicates the UE that the reservation is associated with (e.g., the UE 610 or 615 from which SCI is received). In some aspects, the estimated RSRQ value may be determined by:

$$RSRQ ( 1 , 1 ) = \frac{RSRP ( 1 , 1 )}{( RSRP ( 1 , 2 ) + {N}_{0} )} ,$$

where N₀ is an estimated noise variance value. In a similar manner, the mTRP UE 605 may determine additional estimated RSRQ values for each combination of reservations and TRPs.

As shown by reference number 630, the mTRP UE 605 may determine a communication collision. In some aspects, the mTRP UE 605 may determine the communication collision based at least in part on a mapping function, F, that maps RSRQ values to a modulation and coding scheme (MCS), a quality of service (QoS) class, and/or the like. For example, in some aspects, the mTRP UE 605 determines the communication collision by determining that a minimum value,

$${min}_{m} F ( RSRQ ( m , UEid ) ) ,$$

fails to satisfy a collision threshold:

$${min}_{m} F ( RSRQ ( m , UEid ) ) < {β}^{Thresh} ,$$

where m indexes the TRP, UEid indicates a particular UE, and βl^{Thresh} is a specified threshold. In some aspects, the values of the mapping function correspond to the first set of estimated RSRQ values and the second set of estimated RSRQ values (and any other additional sets of RSRQ values, depending upon the number of UEs).

According to various aspects, the mTRP UE 605 may perform an action based at least in part on determining the collision. For example, as shown by reference number 635, performing the action may include transmitting a collision indication to the UE 610, the UE 615, and/or the like. The corresponding arrow is shown in dashed form to indicate that this action is just one of a number of potential actions that the mTRP UE 605 may perform based at least in part on determining the collision. In some aspects, the mTRP UE 605 may transmit the collision indication over a feedback channel. The feedback channel may include a physical sidelink feedback channel (PSFCH), a dedicated feedback channel, and/or the like.

In some aspects, the mTRP UE 605 may determine a first priority level corresponding to a communication associated with the first reservation (the reservation by the UE 610) and a second priority level corresponding to a communication associated with the second reservation (the reservation by the UE 615). The mTRP UE 605 may determine that the first priority level is greater than the second priority level and may determine an updated first set of estimated RSRQ values based at least in part on the first priority level being greater than the second priority level.

In some aspects, the mTRP UE 605 may determine the updated estimated RSRQ values based at least in part on treating the UE 615 (associated with the lower priority communication) as if the UE 615 will not transmit a communication in accordance with the reservation made by the UE 615. That is, for example, in contrast with the calculation of the first set of estimated RSRQ values, the mTRP UE 605 may determine the updated estimated RSRQ values by performing a recalculation of the first set of estimated RSRQ values where the recalculation is not based at least in part on the second set of RSRP measurements.

In some aspects, the mTRP UE 605 may determine that at least one of the updated first set of estimated RSRQ values satisfies the collision threshold and may, based at least in part on this determination, transmit the collision indication to the third UE. In some aspects, transmitting the collision indication to the third UE may include refraining from transmitting the collision indication to the second UE. In this way, the UE with the lower priority communication may be notified of the collision and take action to avoid the collision. In some aspects, the mTRP UE 605 may determine that all of the updated first set of estimated RSRQ values fail to satisfy a collision threshold, which may indicate that the UE 610, the UE 615, and/or a number of additional UEs are causing the collision. In this case, the mTRP UE 605 may transmit the collision indication to the UE 610, the UE 615, and/or any number of additional UEs within communication range.

According to various aspects, the mTRP UE 605 may determine at least one additional priority level corresponding to at least one additional communication associated with at least one additional reservation of the sidelink resource by at least one additional UE. The at least one additional priority level may be lower than the first priority level (corresponding to the first reservation). In some aspects, the mTRP UE 605 may determine at least one additional set of estimated RSRQ values associated with the at least one additional reservation. The mTRP UE 605 may update at least one of the first set of estimated RSRQ values, the second set of estimated RSRQ values, or the at least one additional set of estimated RSRQ values by performing an iterative updating procedure based at least in part on an order of priority levels associated with the second UE, the third UE, and the at least one additional UE.

In some aspects, the mTRP UE 605 may determine the communication collision by determining that a maximum value,

$${min}_{m} F ( RSRQ ( m , UEid ) ) ,$$

of a plurality of values of a mapping function satisfies a collision threshold:

$${min}_{m} F ( RSRQ ( m , UEid ) ) \geq {β}^{Thresh} ,$$

where m indexes the TRP, UEid indicates a particular UE, and βl^{Thresh} is a specified threshold. In some aspects, the values of the mapping function correspond to the first set of estimated RSRQ values and the second set of estimated RSRQ values (and any other additional sets of RSRQ values, depending upon the number of UEs). The mTRP UE 605 may receive a first demodulation reference signal (DMRS) sequence from the UE 610 and may receive the first DMRS sequence also from the UE 615. In some aspects, the mTRP U 605 may perform the action by transmitting, to the UE 610, an orthogonalization request that requests the UE 610 to transmit a second DMRS sequence, where the second DMRS sequence is orthogonal to the first DMRS sequence.

In some aspects, where DMRS orthogonalization occurs, the mTRP UE 605 may combine the signals on the TRPs for decoding. For example, the mTRP UE 605 may receive, from the UE 610, a first signal comprising a first data communication associated with the sidelink resource. The mTRP UE 605 may receive, from the UE 615, a second signal comprising a second data communication associated with the sidelink resource. The mTRP UE 605 may combine the first signal and the second signal to create a combined signal and may decode, based at least in part on the first DMRS sequence and the second DMRS sequence, the combined signal to extract the first data communication and the second data communication.

In some aspects, where the mTRP UE 605 determines that a maximum value of the plurality of values of the mapping function satisfies the collision threshold, the mTRP UE 605 may not request DMRS orthogonalization. Alternatively, the mTRP UE 605 may determine that a first maximum estimated RSRQ value of the first set of estimated RSRQ values corresponds to a first TRP and that a second maximum estimated RSRQ value of the second set of estimated RSRQ values corresponds to a second TRP. The mTRP UE 605 may receive a first signal from the UE 610 using the first TRP, the first signal comprising a first data communication transmitted via the sidelink resource. The mTRP UE 605 also may receive the first signal from the UE 610 using the second TRP. The mTRP UE 605 may receive a second signal from the UE 615 using the first TRP, the second signal comprising a second data communication transmitted via the sidelink resource. The mTRP UE 605 also may receive the second signal from the UE 615 using the second TRP. The mTRP UE 605 may decode, based at least in part on determining that the first maximum estimated RSRQ value corresponds to the first TRP, the first signal received using the first TRP, to extract the first data communication. Similarly, the mTRP UE 605 may decode, based at least in part on determining that the second maximum estimated RSRQ value corresponds to the second TRP, the second signal received using the second TRP, to extract the second data communication. In some aspects, the mTRP UE 605 may refrain from decoding the first signal received using the second TRP and/or may refrain from decoding the second signal received using the first TRP.

In some aspects, where the mTRP UE 605 determines that a maximum value of the plurality of values of the mapping function satisfies the collision threshold, the mTRP UE 605 may determine that a communication associated with one reservation has a higher priority than another communication associated with another reservation and may prioritize DMRS orthogonalization requests accordingly. For example, the mTRP UE 605 may receive a first DMRS sequence from the UE 610 and from the UE 615. The mTRP UE 605 may determine a first priority level corresponding to a communication associated with the first reservation (associated with the UE 610) and a second priority level corresponding to a communication associated with the second reservation (associated with the UE 615). The mTRP UE 605 may determine that the first priority level is greater than the second priority level. In some aspects, the mTRP UE 605 may, based at least in part on the first priority level being greater than the second priority level, perform the action by transmitting, to the UE 615, an orthogonalization request that requests the UE 615 to transmit a second DMRS sequence that is orthogonal to the first DMRS sequence.

In some aspects, where the mTRP UE 605 determines that a maximum value of the plurality of values of the mapping function satisfies the collision threshold, the mTRP UE 605 may receive a first DMRS sequence from the UE 610 and the UE 615, and may determine that the UE 610 and/or the UE 615 is not able to orthogonalize DMRS sequences. For example, the mTRP UE 605 may receive capability information from the UE 610 and/or the UE 615 that indicates that the UE 610 and/or the UE 615 is incapable of orthogonalizing DMRS sequences, receiving a request to orthogonalize DMRS sequences, and/or the like. In some aspects, the mTRP UE 605 may, based at least in part on that determination, send a collision notification to UEs associated with lower priority communications.

For example, in some aspects, the mTRP UE 605 may determine a first priority level corresponding to a communication associated with the first reservation and a second priority level corresponding to a communication associated with the second reservation. The mTRP UE 605 may determine that the first priority level is greater than the second priority level and that the UE 615 is incapable of transmitting a second DMRS sequence that is orthogonal to the first DMRS sequence (or incapable of decoding a request to do so). Based at least in part on these determinations, the mTRP UE 605 may transmit a collision indication to the UE 615.

In some aspects, the mTRP UE 605 may determine that the UE 610 and/or the UE 615 is incapable of processing a collision indication. For example, in some aspects, the mTRP UE 605 may receive capability information from the UE 610 and/or the UE 615 that facilitates this determination. In some aspects, the capability information may be received in an RRC message. In some aspects, the mTRP UE 605 may make this determination based at least in part on historical information associated with one or more prior communication collisions in which the UE 610 and/or UE 615 did not consider, process, and/or otherwise respond to a collision indication. In some aspects, the mTRP UE 605 may, based at least in part on this determination, use mutually exclusive sets of TRPs to receive the otherwise colliding signals.

For example, in some aspects, the mTRP UE 605 may receive a first signal from the UE 610 using a first TRP, the first signal including a first data communication transmitted via the sidelink resource. The mTRP UE 605 may receive the first signal from the UE 610 using a second TRP, as well. The mTRP 605 also may receive a second signal from the UE 615 using the first TRP and the second TRP, the second signal including a second data communication transmitted via the sidelink resource. In some aspects, the mTRP UE 605 may perform, based at least in part on determining that the UE 610 and/or the UE 615 is incapable of processing a collision indication, a TRP selection process for decoding the first signal and the second signal. The mTRP UE 605 may decode, based at least in part on the TRP selection, the first signal received using one of the first TRP and the second TRP to extract the first data communication and the second signal received using the other one of the first TRP and the second TRP to extract the second data communication.

In some aspects, the mTRP UE 605 may perform the TRP selection process based at least in part on a best effort strategy to maximize decodability. For example, in some aspects, the mTRP UE 605 may obtain a first RSRP measurement associated with the UE 610 and the first TRP, RSRP(1, UE1); a second RSRP measurement associated with the UE 615 and the first TRP, RSRP (1, UE2); a third RSRP measurement associated with the UE 610 and the second TRP, RSRP(2, UE1); and a fourth RSRP measurement associated with the UE 615 and the second TRP, RSRP(2, UE2). The mTRP UE 605 may determine that a difference between the first RSRP measurement and the second RSRP measurement satisfies a decodability threshold, and that a difference between the third RSRP measurement and the fourth RSRP measurement fails to satisfy the decodability threshold. For example, in some aspects, the mTRP UE 605 may determine that RSRP(1, UE1)>>RSRP (1, UE2) and RSRP(2, UE1)≈RSRP(2, UE2). In this case, in some aspects, the mTRP UE 605 may perform the action by decoding the first signal received using the first TRP to extract the first data communication, and decoding the second signal received using the second TRP to extract the second data communication. In some aspects, the mTRP UE 605 may refrain from decoding the first signal received using the second TRP and may refrain from decoding the second signal received using the first TRP.

In some aspects, the mTRP UE 605 may perform the action by decoding the first signal received using the first TRP to create a first decoded signal and decoding the second signal received using the second TRP to create a second decoded signal. In some aspects, the mTRP UE 605 may decode the second signal received using the second TRP by canceling interference received using the second TRP based at least in part on the first decoded signal. In some aspects, the mTRP UE 605 may include a first reception component associated with the first TRP and a second reception component associated with the second TRP. The first reception component may provide the first decoded signal to the second reception component using an in-vehicle wired network, an in-vehicle wireless network, a hardware element shared between the first reception component and the second reception component, and/or the like.

As shown by reference number 645, the UE 610 may transmit, and the mTRP UE 605 may receive, a sidelink transmission associated with the first reservation, and the UE 615 may transmit, and the mTRP UE 605 may receive, a sidelink transmission associated with the second reservation.

As indicated above, FIG. 6 is provided as an example. Other examples may differ from what is described with respect to FIG. 6.

FIG. 7 is a diagram illustrating an example process 700 performed, for example, by a UE, in accordance with various aspects of the present disclosure. Example process 700 is an example where the UE (e.g., UE 120, the mTRP UE 605, and/or the like) performs operations associated with sidelink receiver-side protection for an mTRP UE.

As shown in FIG. 7, in some aspects, process 700 may include determining a communication collision between a first reservation, by a second UE, of a sidelink resource and a second reservation of the sidelink resource based at least in part on a first set of estimated RSRQ values associated with the first reservation and a second set of estimated RSRQ values associated with the second reservation, wherein the first set of estimated RSRQ values corresponds to a plurality of TRPs of the first UE, and wherein the second set of estimated RSRQ values corresponds to the plurality of TRPs (block 710). For example, the UE (e.g., using transmit processor 220, TX MIMO processor 230, modulator 232, antenna 234, demodulator 232, MIMO detector 236, receive processor 238, controller/processor 240, memory 242, and/or scheduler 246; and/or using antenna 252, demodulator 254, MIMO detector 256, receive processor 258, transmit processor 264, TX MIMO processor 266, modulator 254, controller/processor 280, and/or memory 282) may determine a communication collision between a first reservation, by a second UE, of a sidelink resource and a second reservation of the sidelink resource based at least in part on a first set of estimated RSRQ values associated with the first reservation and a second set of estimated RSRQ values associated with the second reservation, wherein the first set of estimated RSRQ values corresponds to a plurality of TRPs of the first UE, and wherein the second set of estimated RSRQ values corresponds to the plurality of TRPs, as described above.

As further shown in FIG. 7, in some aspects, process 700 may include performing an action based at least in part on identifying the communication collision (block 720). For example, the UE (e.g., using transmit processor 220, TX MIMO processor 230, modulator 232, antenna 234, demodulator 232, MIMO detector 236, receive processor 238, controller/processor 240, memory 242, and/or scheduler 246; and/or using antenna 252, demodulator 254, MIMO detector 256, receive processor 258, transmit processor 264, TX MIMO processor 266, modulator 254, controller/processor 280, and/or memory 282) may perform an action based at least in part on identifying the communication collision, as described above.

Process 700 may include additional aspects, such as any single aspect or any combination of aspects described below and/or in connection with one or more other processes described elsewhere herein.

In a first aspect, process 700 includes identifying the first reservation, by the second UE, of the sidelink resource and identifying the second reservation, by the third UE, of the sidelink resource.

In a second aspect, alone or in combination with the first aspect, identifying the first reservation comprises receiving a first SCI transmission associated with the first reservation, and identifying the second reservation comprises receiving a second SCI transmission associated with the second reservation.

In a third aspect, alone or in combination with one or more of the first and second aspects, determining the first set of estimated RSRQ values comprises obtaining, using a first TRP of the plurality of TRPs, a first RSRP measurement corresponding to the first SCI transmission; obtaining, using the first TRP, a second RSRP measurement corresponding to the first SCI transmission; and determining a first estimated RSRQ value of the first set of RSRQ values based at least in part on the first RSRP measurement and the second RSRP measurement.

In a fourth aspect, alone or in combination with one or more of the first through third aspects, determining the first estimated RSRQ value comprises determining a quotient of the first RSRP measurement divided by a divisor that includes the second RSRP measurement.

In a fifth aspect, alone or in combination with one or more of the first through fourth aspects, the divisor comprises a sum of the second RSRP measurement and an estimated noise variance value.

In a sixth aspect, alone or in combination with one or more of the first through fifth aspects, determining the second set of estimated RSRQ values comprises obtaining, using a second TRP of the plurality of TRPs, a third RSRP measurement corresponding to the second SCI transmission; obtaining, using the second TRP, a fourth RSRP measurement corresponding to the second SCI transmission; and determining a second estimated RSRQ value of the second set of estimated RSRQ values based at least in part on the third RSRP measurement and the fourth RSRP measurement.

In a seventh aspect, alone or in combination with one or more of the first through sixth aspects, determining the second estimated RSRQ value comprises determining a quotient of the third RSRP measurement divided by a divisor that includes the fourth RSRP measurement.

In an eighth aspect, alone or in combination with one or more of the first through seventh aspects, the divisor comprises a sum of the fourth RSRP measurement and an estimated noise variance value.

In a ninth aspect, alone or in combination with one or more of the first through eighth aspects, determining the communication collision comprises determining the communication collision based at least in part on a mapping function that maps an RSRQ value of the first set of estimated RSRQ values to at least a modulation and coding scheme, a quality of service class, or some combination thereof.

In a tenth aspect, alone or in combination with one or more of the first through ninth aspects, determining the communication collision comprises determining the communication collision based at least in part on a mapping function that maps an RSRQ value of the second set of estimated RSRQ values to at least a modulation and coding scheme, a quality of service class, or some combination thereof.

In an eleventh aspect, alone or in combination with one or more of the first through tenth aspects, determining the communication collision comprises determining a minimum value of a plurality of values of a mapping function, wherein the plurality of values of the mapping function correspond to the first set of estimated RSRQ values and the second set of estimated RSRQ values; and determining that the minimum value fails to satisfy a collision threshold.

In a twelfth aspect, alone or in combination with one or more of the first through eleventh aspects, performing the action comprises transmitting a collision indication to at least the second UE, the third UE, or some combination thereof.

In a thirteenth aspect, alone or in combination with one or more of the first through twelfth aspects, transmitting the collision indication comprises transmitting the collision indication over a feedback channel.

In a fourteenth aspect, alone or in combination with one or more of the first through thirteenth aspects, the feedback channel comprises a physical sidelink feedback channel or a dedicated feedback channel.

In a fifteenth aspect, alone or in combination with one or more of the first through fourteenth aspects, process 700 includes determining a first priority level corresponding to a communication associated with the first reservation; determining a second priority level corresponding to a communication associated with the second reservation, wherein the first priority level is greater than the second priority level; and determining an updated first set of estimated RSRQ values based at least in part on the first priority level being greater than the second priority level.

In a sixteenth aspect, alone or in combination with one or more of the first through fifteenth aspects, determining the first set of estimated RSRQ values includes performing a calculation of the first set of estimated RSRQ values based at least in part on a first set of reference signal received power (RSRP) measurements associated with the second UE and a second set of RSRP measurements associated with the third UE, and determining the updated first set of estimated RSRQ values comprises performing a recalculation of the first set of estimated RSRQ values, wherein the recalculation is not based at least in part on the second set of RSRP measurements.

In a seventeenth aspect, alone or in combination with one or more of the first through sixteenth aspects, process 700 includes determining that at least one of the updated first set of estimated RSRQ values satisfies a collision threshold, where transmitting the collision indication comprises transmitting the collision indication to the third UE.

In an eighteenth aspect, alone or in combination with one or more of the first through seventeenth aspects, transmitting the collision indication to the third UE comprises refraining from transmitting the collision indication to the second UE.

In a nineteenth aspect, alone or in combination with one or more of the first through eighteenth aspects, process 700 includes determining that all of the updated first set of estimated RSRQ values fail to satisfy a collision threshold, where transmitting the collision indication comprises transmitting the collision indication to the second UE and the third UE.

In a twentieth aspect, alone or in combination with one or more of the first through nineteenth aspects, process 700 includes determining at least one additional priority level corresponding to at least one additional communication associated with at least one additional reservation of the sidelink resource by at least one additional UE, wherein the at least one additional priority level is lower than the first priority level; determining at least one additional set of estimated RSRQ values associated with the at least one additional reservation; and updating at least one of the first set of estimated RSRQ values, the second set of estimated RSRQ values, or the at least one additional set of estimated RSRQ values by performing an iterative updating procedure based at least in part on an order of priority levels associated with the second UE, the third UE, and the at least one additional UE.

In a twenty-first aspect, alone or in combination with one or more of the first through twentieth aspects, determining the communication collision comprises determining a maximum value of a plurality of values of a mapping function, wherein the plurality of values of the mapping function correspond to the first estimated RSRQ and the second estimated RSRQ; and determining that the maximum value satisfies a collision threshold.

In a twenty-second aspect, alone or in combination with one or more of the first through twenty-first aspects, process 700 includes receiving a first DMRS sequence from the second UE; and receiving the first DMRS sequence from the third UE, wherein performing the action comprises transmitting, to the second UE, an orthogonalization request that requests the second UE to transmit a second DMRS sequence, wherein the second DMRS sequence is orthogonal to the first DMRS sequence.

In a twenty-third aspect, alone or in combination with one or more of the first through twenty-second aspects, process 700 includes receiving the second DMRS sequence from the second UE; receiving, from the second UE, a first signal comprising a first data communication associated with the sidelink resource; receiving, from the third UE, a second signal comprising a second data communication associated with the sidelink resource; combining the first signal and the second signal to create a combined signal; and decoding, based at least in part on the first DMRS sequence and the second DMRS sequence, the combined signal to extract the first data communication and the second data communication.

In a twenty-fourth aspect, alone or in combination with one or more of the first through twenty-third aspects, process 700 includes determining that a first maximum estimated RSRQ value of the first set of estimated RSRQ values corresponds to a first TRP of the plurality of TRPs; determining that a second maximum estimated RSRQ value of the second set of estimated RSRQ values corresponds to a second TRP of the plurality of TRPs; receiving a first signal from the second UE using the first TRP, the first signal comprising a first data communication transmitted via the sidelink resource; receiving the first signal from the second UE using the second TRP; receiving a second signal from the third UE using the first TRP, the second signal comprising a second data communication transmitted via the sidelink resource; receiving the second signal from the third UE using the second TRP; decoding, based at least in part on determining that the first maximum estimated RSRQ value corresponds to the first TRP, the first signal received using the first TRP, to extract the first data communication; and decoding, based at least in part on determining that the second maximum estimated RSRQ value corresponds to the second TRP, the second signal received using the second TRP, to extract the second data communication.

In a twenty-fifth aspect, alone or in combination with one or more of the first through twenty-fourth aspects, process 700 includes refraining from decoding the first signal received using the second TRP and refraining from decoding the second signal received using the first TRP.

In a twenty-sixth aspect, alone or in combination with one or more of the first through twenty-fifth aspects, process 700 includes receiving a first DMRS sequence from the second UE; receiving the first DMRS sequence from the third UE; determining a first priority level corresponding to a communication associated with the first reservation; and determining a second priority level corresponding to a communication associated with the second reservation, wherein the first priority level is greater than the second priority level, where, based at least in part on the first priority level being greater than the second priority level, performing the action comprises transmitting, to the second UE, an orthogonalization request that requests the third UE to transmit a second DMRS sequence, wherein the second DMRS sequence is orthogonal to the first DMRS sequence.

In a twenty-seventh aspect, alone or in combination with one or more of the first through twenty-sixth aspects, process 700 includes receiving a first DMRS sequence from the second UE; receiving the first DMRS sequence from the third UE; determining a first priority level corresponding to a communication associated with the first reservation; determining a second priority level corresponding to a communication associated with the second reservation, wherein the first priority level is greater than the second priority level; and determining that the third UE is incapable of transmitting a second DMRS sequence that is orthogonal to the first DMRS sequence, where, based at least in part determining that the third UE is incapable of transmitting the second DMRS sequence that is orthogonal to the first DMRS sequence, performing the action comprises transmitting a collision indication to the third UE.

In a twenty-eighth aspect, alone or in combination with one or more of the first through twenty-seventh aspects, process 700 includes determining that at least the second UE, the third UE, or some combination thereof is incapable of processing a collision indication; receiving a first signal from the second UE using a first TRP of the plurality of TRPs, the first signal comprising a first data communication transmitted via the sidelink resource; receiving the first signal from the second UE using a second TRP of the plurality of TRPs; receiving a second signal from the third UE using the first TRP, the second signal comprising a second data communication transmitted via the sidelink resource; receiving the second signal from the third UE using the second TRP; performing, based at least in part on determining that at least the second UE, the third UE, or some combination thereof is incapable of processing a collision indication, a TRP selection process for decoding the first signal and the second signal; decoding, based at least in part on the TRP selection, the first signal received using one of the first TRP and the second TRP to extract the first data communication; and decoding, based at least in part on the TRP selection, the second signal received using the other one of the first TRP and the second TRP to extract the second data communication.

In a twenty-ninth aspect, alone or in combination with one or more of the first through twenty-eighth aspects, determining that at least the second UE, the third UE, or some combination thereof is incapable of processing a collision indication comprises determining that at least the second UE, the third UE, or some combination thereof is incapable of processing a collision indication based at least in part on at least a prior communication collision in which a collision indication was not considered, a set of UE capability information associated with at least the second UE, the third UE, or some combination thereof, or some combination thereof.

In a thirtieth aspect, alone or in combination with one or more of the first through twenty-ninth aspects, process 700 includes receiving an RRC message, where the RRC message includes the set of UE capability information.

In a thirty-first aspect, alone or in combination with one or more of the first through thirtieth aspects, the TRP selection process is based at least in part on a best effort strategy to maximize decodability.

In a thirty-second aspect, alone or in combination with one or more of the first through thirty-first aspects, process 700 includes obtaining a first RSRP measurement associated with the second UE and the first TRP; obtaining a second RSRP measurement associated with the third UE and the first TRP; obtaining a third RSRP measurement associated with the second UE and the second TRP; obtaining a fourth RSRP measurement associated with the third UE and the second TRP; determining that a difference between the first RSRP measurement and the second RSRP measurement satisfies a decodability threshold; and determining that a difference between the third RSRP measurement and the fourth RSRP measurement fails to satisfy the decodability threshold.

In a thirty-third aspect, alone or in combination with one or more of the first through thirty-second aspects, performing the action comprises decoding, based at least in part on determining that the difference between the first RSRP measurement and the second RSRP measurement satisfies the decodability threshold, the first signal received using the first TRP, to extract the first data communication.

In a thirty-fourth aspect, alone or in combination with one or more of the first through thirty-third aspects, decoding the first signal received using the first TRP comprises refraining from decoding the first signal received using the second TRP.

In a thirty-fifth aspect, alone or in combination with one or more of the first through thirty-fourth aspects, performing the action comprises decoding, based at least in part on determining that the difference between the first RSRP measurement and the second RSRP measurement satisfies the decodability threshold, the second signal received using the second TRP, to extract the second data communication.

In a thirty-sixth aspect, alone or in combination with one or more of the first through thirty-fifth aspects, decoding the second signal received using the second TRP comprises refraining from decoding the second signal received using the first TRP.

In a thirty-seventh aspect, alone or in combination with one or more of the first through thirty-sixth aspects, performing the action comprises decoding the first signal received using the first TRP to create a first decoded signal; and decoding the second signal received using the second TRP to create a second decoded signal, wherein decoding the second signal received using the second TRP comprises canceling interference received using the second TRP based at least in part on the first decoded signal.

In a thirty-eighth aspect, alone or in combination with one or more of the first through thirty-seventh aspects, the first UE comprises a first reception component associated with the first TRP and a second reception component associated with the second TRP.

In a thirty-ninth aspect, alone or in combination with one or more of the first through thirty-eighth aspects, performing the action comprises providing the first decoded signal from the first reception component to the second reception component using at least an in-vehicle wired network, a hardware element shared between the first reception component and the second reception component, or some combination thereof.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

The foregoing disclosure provides illustration and description, but is not intended to be exhaustive or to limit the aspects to the precise form disclosed. Modifications and variations may be made in light of the above disclosure or may be acquired from practice of the aspects.

As used herein, the term “component” is intended to be broadly construed as hardware, firmware, and/or a combination of hardware and software. As used herein, a processor is implemented in hardware, firmware, and/or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

As used herein, satisfying a threshold may, depending on the context, refer to a value being greater than the threshold, greater than or equal to the threshold, less than the threshold, less than or equal to the threshold, equal to the threshold, not equal to the threshold, and/or the like.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” and/or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method of wireless communication performed by a first user equipment (UE), comprising:
determining a communication collision between a first reservation, by a second UE, of a sidelink resource and a second reservation, by a third UE, of the sidelink resource based at least in part on a first set of estimated reference signal received quality (RSRQ) values associated with the first reservation and a second set of estimated RSRQ values associated with the second reservation, wherein the first set of estimated RSRQ values corresponds to a plurality of transmitter-receiver points (TRPs) of the first UE, and wherein the second set of estimated RSRQ values corresponds to the plurality of TRPs; and
performing an action based at least in part on identifying the communication collision.

2. The method of claim 1, further comprising:
identifying the first reservation, by the second UE, of the sidelink resource; and
identifying the second reservation, by the third UE, of the sidelink resource.

3. The method of claim 1, wherein identifying the first reservation comprises receiving a first sidelink control information (SCI) transmission associated with the first reservation, and
wherein identifying the second reservation comprises receiving a second SCI transmission associated with the second reservation.

4. The method of claim 3, wherein determining the first set of estimated RSRQ values comprises:
obtaining, using a first TRP of the plurality of TRPs, a first reference signal received power (RSRP) measurement corresponding to the first SCI transmission;
obtaining, using the first TRP, a second RSRP measurement corresponding to the first SCI transmission; and
determining a first estimated RSRQ value of the first set of RSRQ values based at least in part on the first RSRP measurement and the second RSRP measurement.

5. The method of claim 4, wherein determining the first estimated RSRQ value comprises determining a quotient of the first RSRP measurement divided by a divisor that includes the second RSRP measurement.

6. The method of claim 5, wherein the divisor comprises a sum of the second RSRP measurement and an estimated noise variance value.

7. The method of claim 4, wherein determining the second set of estimated RSRQ values comprises:
obtaining, using a second TRP of the plurality of TRPs, a third RSRP measurement corresponding to the second SCI transmission;
obtaining, using the second TRP, a fourth RSRP measurement corresponding to the second SCI transmission; and
determining a second estimated RSRQ value of the second set of estimated RSRQ values based at least in part on the third RSRP measurement and the fourth RSRP measurement.

8. The method of claim 7, wherein determining the second estimated RSRQ value comprises determining a quotient of the third RSRP measurement divided by a divisor that includes the fourth RSRP measurement.

9. The method of claim 8, wherein the divisor comprises a sum of the fourth RSRP measurement and an estimated noise variance value.

10. The method of claim 1, wherein determining the communication collision comprises determining the communication collision based at least in part on a mapping function that maps an RSRQ value of the first set of estimated RSRQ values to at least:
a modulation and coding scheme,
a quality of service class, or
some combination thereof.

11. The method of claim 1, wherein determining the communication collision comprises determining the communication collision based at least in part on a mapping function that maps an RSRQ value of the second set of estimated RSRQ values to at least:
a modulation and coding scheme,
a quality of service class, or
some combination thereof.

12. The method of claim 1, wherein determining the communication collision comprises:
determining a minimum value of a plurality of values of a mapping function, wherein the plurality of values of the mapping function correspond to the first set of estimated RSRQ values and the second set of estimated RSRQ values; and
determining that the minimum value fails to satisfy a collision threshold.

13. The method of claim 1, wherein performing the action comprises transmitting a collision indication to at least:
the second UE,
the third UE, or
some combination thereof.

14. The method of claim 13, wherein transmitting the collision indication comprises transmitting the collision indication over a feedback channel.

15. The method of claim 14, wherein the feedback channel comprises a physical sidelink feedback channel or a dedicated feedback channel.

16. The method of claim 13, further comprising:
determining a first priority level corresponding to a communication associated with the first reservation;
determining a second priority level corresponding to a communication associated with the second reservation, wherein the first priority level is greater than the second priority level; and
determining an updated first set of estimated RSRQ values based at least in part on the first priority level being greater than the second priority level.

17. The method of claim 16, wherein determining the first set of estimated RSRQ values includes performing a calculation of the first set of estimated RSRQ values based at least in part on a first set of reference signal received power (RSRP) measurements associated with the second UE and a second set of RSRP measurements associated with the third UE, and
wherein determining the updated first set of estimated RSRQ values comprises performing a recalculation of the first set of estimated RSRQ values wherein the recalculation is not based at least in part on the second set of RSRP measurements.

18. The method of claim 17, further comprising:
determining that at least one of the updated first set of estimated RSRQ values satisfies a collision threshold,
wherein transmitting the collision indication comprises transmitting the collision indication to the third UE.

19. The method of claim 18, wherein transmitting the collision indication to the third UE comprises refraining from transmitting the collision indication to the second UE.

20. The method of claim 17, further comprising:
determining that all of the updated first set of estimated RSRQ values fail to satisfy a collision threshold,
wherein transmitting the collision indication comprises transmitting the collision indication to the second UE and the third UE.

21. The method of claim 16, further comprising:
determining at least one additional priority level corresponding to at least one additional communication associated with at least one additional reservation of the sidelink resource by at least one additional UE, wherein the at least one additional priority level is lower than the first priority level;
determining at least one additional set of estimated RSRQ values associated with the at least one additional reservation; and
updating at least one of the first set of estimated RSRQ values, the second set of estimated RSRQ values, or the at least one additional set of estimated RSRQ values by performing an iterative updating procedure based at least in part on an order of priority levels associated with the second UE, the third UE, and the at least one additional UE.

22. The method of claim 1, wherein determining the communication collision comprises:
determining a maximum value of a plurality of values of a mapping function, wherein the plurality of values of the mapping function correspond to the first estimated RSRQ and the second estimated RSRQ; and
determining that the maximum value satisfies a collision threshold.

23. The method of claim 1, further comprising:
receiving a first demodulation reference signal (DMRS) sequence from the second UE; and
receiving the first DMRS sequence from the third UE,
wherein performing the action comprises transmitting, to the second UE, an orthogonalization request that requests the second UE to transmit a second DMRS sequence, wherein the second DMRS sequence is orthogonal to the first DMRS sequence.

24. The method of claim 23, further comprising:
receiving the second DMRS sequence from the second UE;
receiving, from the second UE, a first signal comprising a first data communication associated with the sidelink resource;
receiving, from the third UE, a second signal comprising a second data communication associated with the sidelink resource;
combining the first signal and the second signal to create a combined signal; and
decoding, based at least in part on the first DMRS sequence and the second DMRS sequence, the combined signal to extract the first data communication and the second data communication.

25. The method of claim 1, further comprising:
determining that a first maximum estimated RSRQ value of the first set of estimated RSRQ values corresponds to a first TRP of the plurality of TRPs;
determining that a second maximum estimated RSRQ value of the second set of estimated RSRQ values corresponds to a second TRP of the plurality of TRPs;
receiving a first signal from the second UE using the first TRP, the first signal comprising a first data communication transmitted via the sidelink resource;
receiving the first signal from the second UE using the second TRP;
receiving a second signal from the third UE using the first TRP, the second signal comprising a second data communication transmitted via the sidelink resource;
receiving the second signal from the third UE using the second TRP;
decoding, based at least in part on determining that the first maximum estimated RSRQ value corresponds to the first TRP, the first signal received using the first TRP, to extract the first data communication; and
decoding, based at least in part on determining that the second maximum estimated RSRQ value corresponds to the second TRP, the second signal received using the second TRP, to extract the second data communication.

26. The method of claim 25, further comprising:
refraining from decoding the first signal received using the second TRP; and
refraining from decoding the second signal received using the first TRP.

27. The method of claim 1, further comprising:
receiving a first demodulation reference signal (DMRS) sequence from the second UE;
receiving the first DMRS sequence from the third UE;
determining a first priority level corresponding to a communication associated with the first reservation; and
determining a second priority level corresponding to a communication associated with the second reservation, wherein the first priority level is greater than the second priority level,
wherein, based at least in part on the first priority level being greater than the second priority level, performing the action comprises transmitting, to the second UE, an orthogonalization request that requests the third UE to transmit a second DMRS sequence, wherein the second DMRS sequence is orthogonal to the first DMRS sequence.

28. The method of claim 1, further comprising:
receiving a first demodulation reference signal (DMRS) sequence from the second UE;
receiving the first DMRS sequence from the third UE;
determining a first priority level corresponding to a communication associated with the first reservation;
determining a second priority level corresponding to a communication associated with the second reservation, wherein the first priority level is greater than the second priority level; and
determining that the third UE is incapable of transmitting a second DMRS sequence that is orthogonal to the first DMRS sequence,
wherein, based at least in part determining that the third UE is incapable of transmitting the second DMRS sequence that is orthogonal to the first DMRS sequence, performing the action comprises transmitting a collision indication to the third UE.

29. The method of claim 1, further comprising:
determining that at least the second UE, the third UE, or some combination thereof is incapable of processing a collision indication;
receiving a first signal from the second UE using a first TRP of the plurality of TRPs, the first signal comprising a first data communication transmitted via the sidelink resource;
receiving the first signal from the second UE using a second TRP of the plurality of TRPs;
receiving a second signal from the third UE using the first TRP, the second signal comprising a second data communication transmitted via the sidelink resource;
receiving the second signal from the third UE using the second TRP;
performing, based at least in part on determining that at least the second UE, the third UE, or some combination thereof is incapable of processing a collision indication, a TRP selection process for decoding the first signal and the second signal;
decoding, based at least in part on the TRP selection, the first signal received using one of the first TRP and the second TRP to extract the first data communication; and
decoding, based at least in part on the TRP selection, the second signal received using the other one of the first TRP and the second TRP to extract the second data communication.

30. The method of claim 29, wherein determining that at least the second UE, the third UE, or some combination thereof is incapable of processing a collision indication comprises determining that at least the second UE, the third UE, or some combination thereof is incapable of processing a collision indication based at least in part on at least:
a prior communication collision in which a collision indication was not considered,
a set of UE capability information associated with at least the second UE, the third UE, or some combination thereof, or
some combination thereof.

31. The method of claim 30, further comprising receiving a radio resource control (RRC) message, wherein the RRC message includes the set of UE capability information.

32. The method of claim 29, wherein the TRP selection process is based at least in part on a best effort strategy to maximize decodability.

33. The method of claim 29, further comprising:
obtaining a first reference signal received power (RSRP) measurement associated with the second UE and the first TRP;
obtaining a second RSRP measurement associated with the third UE and the first TRP;
obtaining a third RSRP measurement associated with the second UE and the second TRP;
obtaining a fourth RSRP measurement associated with the third UE and the second TRP;
determining that a difference between the first RSRP measurement and the second RSRP measurement satisfies a decodability threshold; and
determining that a difference between the third RSRP measurement and the fourth RSRP measurement fails to satisfy the decodability threshold.

34. The method of claim 33, wherein performing the action comprises:
decoding, based at least in part on determining that the difference between the first RSRP measurement and the second RSRP measurement satisfies the decodability threshold, the first signal received using the first TRP, to extract the first data communication.

35. The method of claim 34, wherein decoding the first signal received using the first TRP comprises refraining from decoding the first signal received using the second TRP.

36. The method of claim 33, wherein performing the action comprises:
decoding, based at least in part on determining that the difference between the first RSRP measurement and the second RSRP measurement satisfies the decodability threshold, the second signal received using the second TRP, to extract the second data communication.

37. The method of claim 36, wherein decoding the second signal received using the second TRP comprises refraining from decoding the second signal received using the first TRP.

38. The method of claim 33, wherein performing the action comprises:
decoding the first signal received using the first TRP to create a first decoded signal; and
decoding the second signal received using the second TRP to create a second decoded signal,
wherein decoding the second signal received using the second TRP comprises canceling interference received using the second TRP based at least in part on the first decoded signal.

39. The method of claim 38, wherein the first UE comprises:
a first reception component associated with the first TRP; and
a second reception component associated with the second TRP.

40. The method of claim 39, wherein performing the action comprises:
providing the first decoded signal from the first reception component to the second reception component using at least:
an in-vehicle wired network,
a hardware element shared between the first reception component and the second reception component, or
some combination thereof.

41. A first user equipment (UE) for wireless communication, comprising:
a memory; and
one or more processors operatively coupled to the memory, the memory and the one or more processors configured to:
determine a communication collision between a first reservation, by a second UE, of a sidelink resource and a second reservation of the sidelink resource based at least in part on a first set of estimated reference signal received quality (RSRQ) values associated with the first reservation and a second set of estimated RSRQ values associated with the second reservation, wherein the first set of estimated RSRQ values corresponds to a plurality of transmitter-receiver points (TRPs) of the first UE, and wherein the second set of estimated RSRQ values corresponds to the plurality of TRPs; and
perform an action based at least in part on identifying the communication collision.

42. A non-transitory computer-readable medium storing a set of instructions for wireless communication, the set of instructions comprising:
one or more instructions that, when executed by one or more processors of a first user equipment (UE), cause the UE to:
determine a communication collision between a first reservation, by a second UE, of a sidelink resource and a second reservation of the sidelink resource based at least in part on a first set of estimated reference signal received quality (RSRQ) values associated with the first reservation and a second set of estimated RSRQ values associated with the second reservation, wherein the first set of estimated RSRQ values corresponds to a plurality of transmitter-receiver points (TRPs) of the first UE, and wherein the second set of estimated RSRQ values corresponds to the plurality of TRPs; and
perform an action based at least in part on identifying the communication collision.

43. An apparatus for wireless communication, comprising:
means for determining a communication collision between a first reservation, by a second apparatus, of a sidelink resource and a second reservation of the sidelink resource based at least in part on a first set of estimated reference signal received quality (RSRQ) values associated with the first reservation and a second set of estimated RSRQ values associated with the second reservation, wherein the first set of estimated RSRQ values corresponds to a plurality of transmitter-receiver points (TRPs) of the first apparatus, and wherein the second set of estimated RSRQ values corresponds to the plurality of TRPs; and
means for performing an action based at least in part on identifying the communication collision.
